(19) United States
(12) Patent Application Publication
(10) Pub. No.: US 2023/0035142 A1
(43) Pub. Date: Feb. 2, 2023

(54) INPUT WORK ITEM FLOW METRIC FOR COMPUTING ENVIRONMENT TELEMETRY

(71) Applicant: Intel Corporation, Santa Clara, CA (US)

(72) Inventors: Chris MACNAMARA, Limerick (IE); David HUNT, Meelick (IE); Kevin LAATZ, Limerick (IE); Anatoly BURAKOV, Shannon (IE); Bruce RICHARDSON, Shannon (IE); Conor WALSH, Tullamore (IE); John J. BROWNE, Limerick (IE)

(21) Appl. No.: 17/966,441

(22) Filed: Oct. 14, 2022

Related U.S. Application Data
(60) Provisional application No. 63/389,122, filed on Jul. 14, 2022.

(51) Int. Cl. G06F 9/50

(52) U.S. Cl. CPC G06F 9/5027

(57) ABSTRACT

A method is described. The method includes polling a queue a plurality of times over a plurality of intervals, where, the queue feeds work items to a processor. The method includes determining, from the polling, respective work item flow metrics for the plurality of intervals. The method includes determining a processor's performance setting based on the plurality of respective work item flow metrics.

### RELATED APPLICATIONS

This application claims the benefit of U.S. Provisional Application No. 63/389,122, entitled, “APPLICATION BUSYNESS METRIC FOR COMPUTING ENVIRONMENT TELEMETRY”, filed Jul. 14, 2022, which is incorporated by reference in its entirety.

### BACKGROUND

Today's data center and other high performance computing environments commonly include many (e.g., thousands of) different instances of concurrently executing software applications. System engineers are constantly seeking ways to monitor the software applications so that the operation and/or control of the data center/high performance computing environment can be controlled with some degree of precision.

### FIGURES

FIG. 1 shows a processor and input queue;

FIG. 2 shows a burst of input work items;

FIG. 3 shows modulation of processor performance level in view of input queue business as measured at periodic telemetry intervals;

FIG. 4a shows N polls of an input queue being taken per telemetry interval;

FIG. 4b shows a methodology for tracking the poll results of FIG. 4a;

FIG. 5 shows different thresholds of queue business used to affect processor performance level;

FIG. 6 shows polling of multiple input queues;

FIG. 7 shows an architecture for determining processor performance level based on the business metrics for multiple input queues;

FIGS. 8a and 8b show different hardware implementations;

FIG. 9 shows a system;

FIG. 10 shows a data center;

FIG. 11 shows a rack.

### DETAILED DESCRIPTION

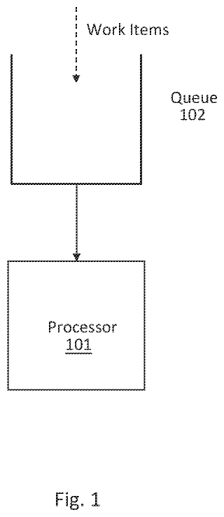

FIG. 1 shows a high level view of a processor 101 and a queue 102 that feeds work items to the processor 101. According to nominal operation, work items are entered into the queue 102. When the processor 101 has resources to process a next work item, a work item is serviced from the queue 102 and processed by the processor 101.

The work items are typically input data for any of a multitude of different tasks that the processor 101 is configured to execute. For example, according to one possible scenario, the processor 101 has been configured to execute a particular application software program (e.g., a network packet header processing application) and the queue 102 is implemented in the processor's main memory (e.g., packet headers are written into address space of main memory that has been allocated for the queue). Over the course of execution of the software program, the processor 101 reads input data items from the region of main memory that corresponds to the queue 102 thereby effectively servicing work items from the queue 102.

Importantly, the processor's performance level can be changed, e.g., as a function of its workload. For example, if work items are entered into the queue 102 at a high rate, the processor's performance level can be increased to handle the high input work flow (e.g., one or more processor instruction execution pipelines are enabled, the respective frequency of one or more processor clocks are increased, etc.). By contrast, if work items are entered into the queue 102 at a low rate, the processor's performance level can be decreased to conserve energy (e.g., one or more processor instruction execution pipelines are disabled, the respective frequency of one or more processor clocks are decreased, etc.).

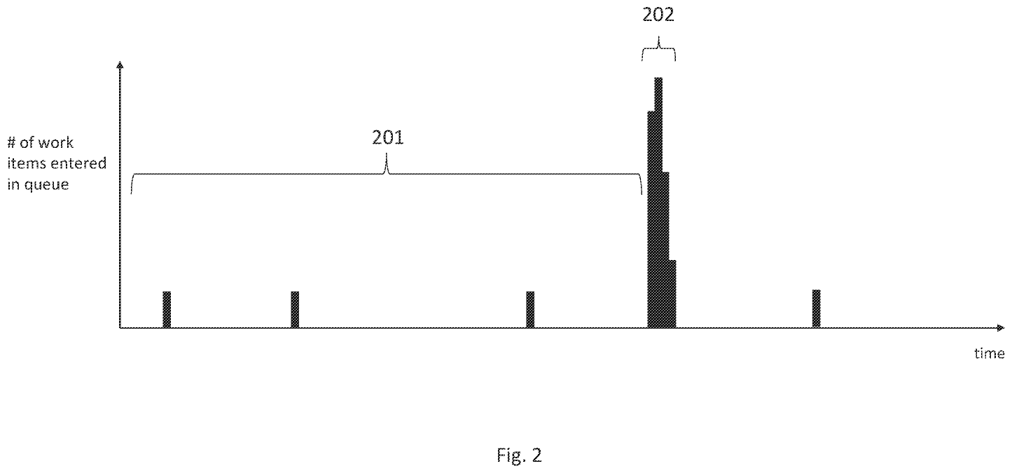

A challenge, however, is the “bursty” nature at which work items are entered into the queue 102. For example, referring to FIG. 2, over an extended period of time 201, little or no work items are entered into the queue 102. Then, suddenly, a large number of work items are rapidly entered into the queue in a brief amount of time 202. Ideally, the processor's performance level is low during the first time period 201 so that energy is conserved when little/no work is being performed and then is increased to respond to the sudden increase in work items in time period 202.

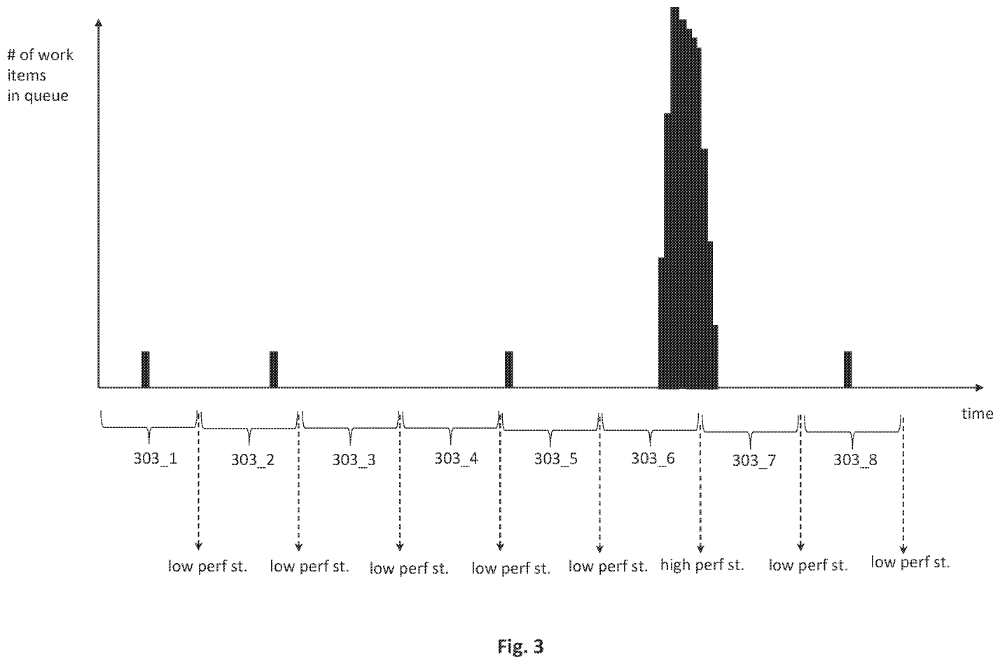

FIG. 3 depicts a high level view of a process for modulating the processor's performance level in view of the number of work items in the queue. As will be explained in more detail immediately below, the process monitors the state of the input queue with a temporal granularity (“telemetry interval”) that allows for quick identification of a sudden change in the number of works item in the queue. By adjusting the processor's performance level in step with the flow of input work items, the balance between processor performance and processor power consumption are adeptly managed.

FIG. 3 depicts an example where multiple telemetry intervals 301_1 through 303_5 transpire in which little/no work items are entered in the queue and the processor is kept in a low performance state (“low perf. st.”).

Here, at the end of each telemetry interval, the algorithm determines the processor's performance state based on the number of work items in the queue. Thus, at the end of each of telemetry intervals 301_1 through 301_5, with the number of work items in the queue being, e.g., below some threshold, the algorithm causes the processor stay in a low performance state. With little/no work items in the queue during each of telemetry intervals 301_1 through 301_5, the number of work items in the queue remains low and the processor can adequately service these work items even though the processor is in a low performance state.

Then, a burst of work items suddenly arrives within telemetry interval 303_6. Because the processor is in a low performance state during telemetry interval 303_6, the processor is only able to minimally reduce the number of work items in the queue during telemetry interval 303_6. However, with the number of work items in the queue being, e.g., above some threshold at the end of a telemetry interval 303_6, the algorithm is able to detect the burst and causes the process to enter a high performance state.

The processor then processes the queue's work items through telemetry interval 303_7 in a high performance state and rapidly services the work items from the queue. In the particular example of FIG. 3, the processor is able to consume all of the work items within telemetry interval 303_7 and the algorithm determines at the end of telemetry interval 303_7 that the state of the queue over the course of telemetry interval 303_7 justifies lowering the processor's performance level back to the low performance state.

Thereafter (telemetry interval 303_8) only few work items are entered in the queue and the processor remains in the low performance state.

Notably, the overall time that the processor operates in the high performance state is comparable to the temporal width of the burst which, in turn, translates to adept processor performance level management (e.g., the processor operates in a high performance state when large numbers of work items are present in the queue and in a low performance state at other times).

In various embodiments, the temporal width of the telemetry interval is “tuned” to be comparable with the time span over which a burst of incoming work items typically arrive (e.g., a modest fraction thereof ( 1/10^{th} or larger), a modest multiple thereof (×10 or less), etc.). Here, characteristic burst widths can be determined by monitoring system traffic flows that feed the input queue. The temporal width of the telemetry interval can then be set based on the characteristic burst width(s).

In the particular example of FIG. 3 a single burst transpired within a single telemetry interval (303_6) and its work items were completely serviced within a single telemetry interval (303_7). In other systems/implementations, multiple bursts may be received within a single telemetry interval, a single burst may occur over a plurality of consecutive telemetry intervals and/or a plurality of consecutive telemetry intervals may be needed to fully service a single burst's work items. Here, generally, the shorter the telemetry interval relative to the time span of a burst the more telemetry intervals a single burst will span across.

Likewise, the greater the processor's processing ability in a high performance state and the longer the telemetry interval, the more likely the processor can empty a burst of work items from the queue in a single telemetry interval. Conversely, the less the processor's processing ability in a high performance state and the shorter the telemetry interval, the more likely it is that multiple consecutive telemetry intervals will be needed to reduce the number of work items in the queue to a level that justifies changing the processor's performance level to a low performance state.

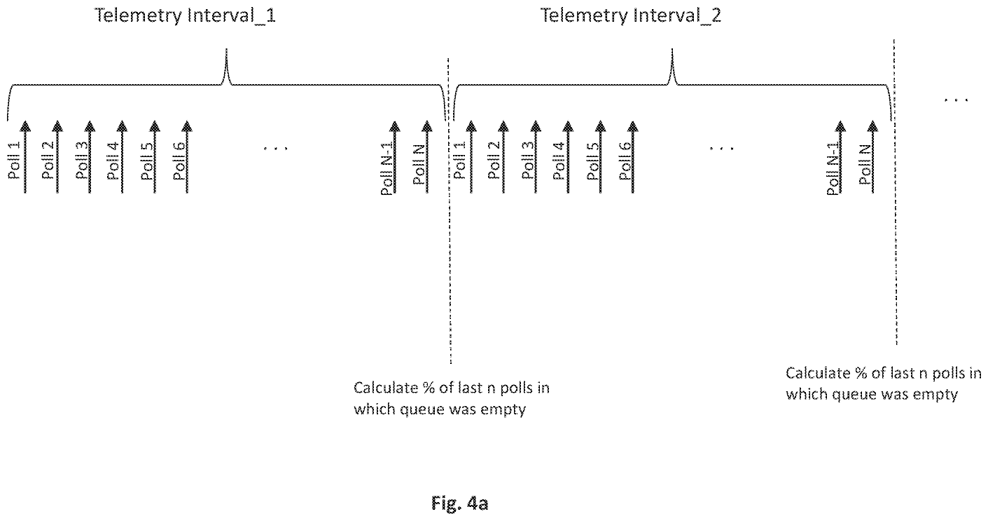

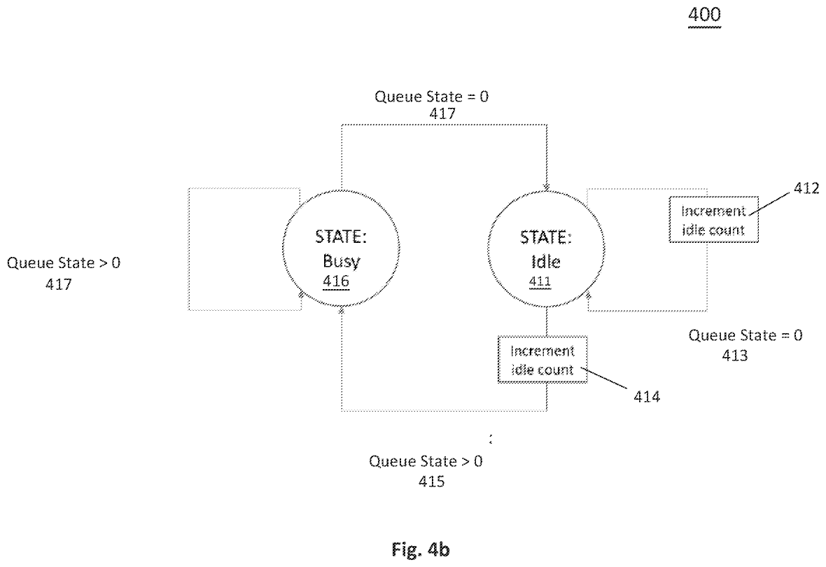

FIGS. 4a and 4b pertain to an embodiment of a methodology 400 for accessing the extent to which the input queue is populated with work items. As discussed above, the extent to which the input queue is populated with work items can be used to determine the processor's performance level.

An issue with determining work item content in the input queue is that the number of work items within the queue can vary during a telemetry interval. Specifically, not only can work items be entered into the queue during the telemetry interval, but also, the processor can service work items from the queue during the telemetry interval. Thus, at any particular moment of time within a telemetry interval, the “number” of work items can be dramatically different than some other moment of time within the telemetry interval.

In order to address this issue, as observed in FIG. 4a, the input queue is polled N times during each telemetry interval. Each poll determines the number of work items in the queue at the moment in time the poll is taken. Thus, during a particular telemetry interval, the number of work items in the queue is separately determined N different times. According to the particular embodiment of FIGS. 4a and 4b, if the queue is empty when a poll is taken (no work items are present in the queue when the poll is taken) a queue status of “idle” is assigned for that poll. Likewise, if the queue is not empty when a poll is taken (at least one work item is present in the queue when the poll is taken) a queue status of “busy” is assigned for that poll.

Thus, over the course of a telemetry interval, there are N different assessments of whether the queue is idle or busy (empty or non-empty). At the completion of the telemetry interval (after N different idle/busy assessments have been made for the telemetry interval in question), the total number of idle polls that occurred during the telemetry interval are used to gauge whether the processor is keeping up with the rate at which work items are being entered into the queue.

More specifically, if a threshold percentage of the N polls were idle, the processor is deemed to be keeping pace with the rate at which work items are being entered into the queue. As such, the processor can remain at its current performance level. By contrast, if less than the threshold percentage of the N assessments were idle, the processor is deemed to not be keeping pace with the rate at which work items are being entered into the queue and the processor is triggered into a higher performance level.

FIG. 4b depicts a particular embodiment for counting the number of idle polls during a telemetry interval. According to the approach of FIG. 4b, a next poll during the telemetry interval is a state transition in the depicted state diagram 410. If the immediately prior poll resulted in an idle state 411, the idle count is incremented 412 if the next poll is also idle 413. The poll state then remains at idle 411. Thus, the idle count will continually increment with each immediately successive poll whose result is idle. By contrast, if the immediately prior poll resulted in an idle state 411 but the next poll determines the queue is busy 415, the idle count is incremented 414 but the polls state is switched to busy 416.

With each successive busy poll 417 from the busy state 416 the idle count will remain constant (will not be incremented). By contrast, if a next poll from the busy state 416 determines that the queue is idle 418, the state transitions from the busy state 416 to the idle state 411. The idle count is not incremented during this transition 418 because previous idle states are effectively counted (increment 414 accounts for the immediately prior idle poll).

After N polls have been taken, the percentage of idle counts across the N polls is calculated. If the percentage is below some threshold the processor's performance level is increased. Then, the idle count is cleared and a next set of N polls are performed for the next telemetry interval.

In other embodiments, the count can be incremented based on the current poll rather than the previous poll (in this case, increment 414 is moved from transition 415 to transition 417. Moreover, alternatively, busy states (previous or current) can be counted instead of idle states. In this case, the processor's performance level is increased if the percentage of busy states rises above some threshold. As such, more generally, the polling activity monitors some work item input flow metric (“business” metric) of the input queue which, in turn, includes some measurement of the queue state (the number of input items in the queue) or parameter that affects the queue state. For ease of discussion the following discussion will mainly assume the work item input flow metric is the idleness metric as described above.

Any/all of these methodologies use the N polls per telemetry interval to gauge whether the processor's current performance level can adequately service the work items in the input queue. More specifically, if a large percentage of the N polls observe an empty (idle) queue, then, the processor is adequately servicing the queue (the processor is able to “empty out” the queue in between polls). As such, the performance level of the processor need not be increased. By contrast, if a large percentage of the N assessments observe a non empty (busy) queue, then, the processor is not regularly emptying the queue in between polls which indicates that the processor's current service rate is struggling to keep up with the rate at which input items are being entered in the queue. In this case the processor's performance level should be increased.

Note that the above described mechanism is relatively indifferent to how frequently the polls are made. That is, so long as the time periods that elapse between consecutive polls are not extremely long or extremely short, the processor should be able to empty out the queue between consecutive polls if the processor is keeping up with the rate at which input items are being entered into the queue. Thus, polls can be made (e.g., periodically) within a wide range of temporal frequencies (e.g., polls are made within a range from every few nanoseconds to every few milliseconds). In alternate or combined embodiments polls can be made in response to certain looked for events rather than periodically (e.g., changes in processor workload, changes in memory workload, changes in network interface traffic, etc.).

Although embodiments described above have been directed to determining whether the processor should be placed in a high or low performance state, in other embodiments the processor is able to entertain a range or scale of multiple performance levels beyond just high and low performance levels. Here, the above described methodologies can be used with multiple thresholds to determine at the end of each telemetry interval whether the processor's performance level should be: 1) increased from its current level; 2) maintained at its current level; or, 3) lowered from its current level.

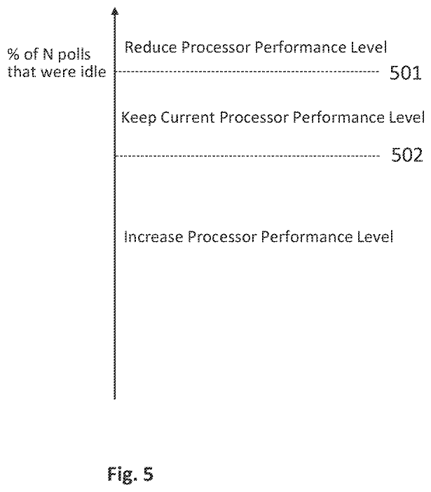

Here, for example, referring to FIG. 5, if the percentage of idle polls of a telemetry interval rises above a high threshold 501 then the processor's current performance level should be lowered (the processor is emptying out the input queue so frequently that the processor is operating at too high a performance level). By contrast, if the percentage of idle polls of a telemetry interval falls below a low threshold 502 then the processor's current performance state should be increased (the processor is struggling to keep up with the rate at which work items are being entered in the queue).

If the percentage of a telemetry interval's idle polls falls between these two thresholds 501, 502 the processor's current performance level is maintained (the processor is not emptying out the queue too frequently nor is the processor struggling to keep up with the input flow of work items).

The processor as described above can be any focal point of processing activity such as a multicore general purpose processor (or a core thereof), a special purpose processor (e.g., accelerator, network processor, graphics processor, infrastructure processing unit (IPU)), controller or other logic block that executes program code and/or uses dedicated logic circuitry (e.g., hardwired such as an application specific integrated circuit (ASIC) and/or programmed such as a field programmable gate array (FPGA)) to implement its functionality. Memory that is coupled to or otherwise accessible to the processor can be used to implement an input queue.

The processor can be a central processing unit (CPU) or component thereof, an ancillary or offload processing unit (such as any of the special purpose processor listed above), a controller of a peripheral component that plugs into a larger system (such as a network interface card or module, a solid state drive, etc.). In various embodiments the primary processing activity of the processor is fed by the aforementioned input queue such that the processor's performance level is determined largely by the state of the single input as described above.

In other embodiments the processor executes multiple functions each having their own dedicated input queue. Here, processor performance level can be determined, e.g., from the combined state of the multiple input queues. For example, in various embodiments the processor is configured to concurrently execute multiple application software programs, where each program has its own dedicated input queue in main memory. In this case, respective telemetry intervals for the multiple input queues can be concurrently polled by the processor.

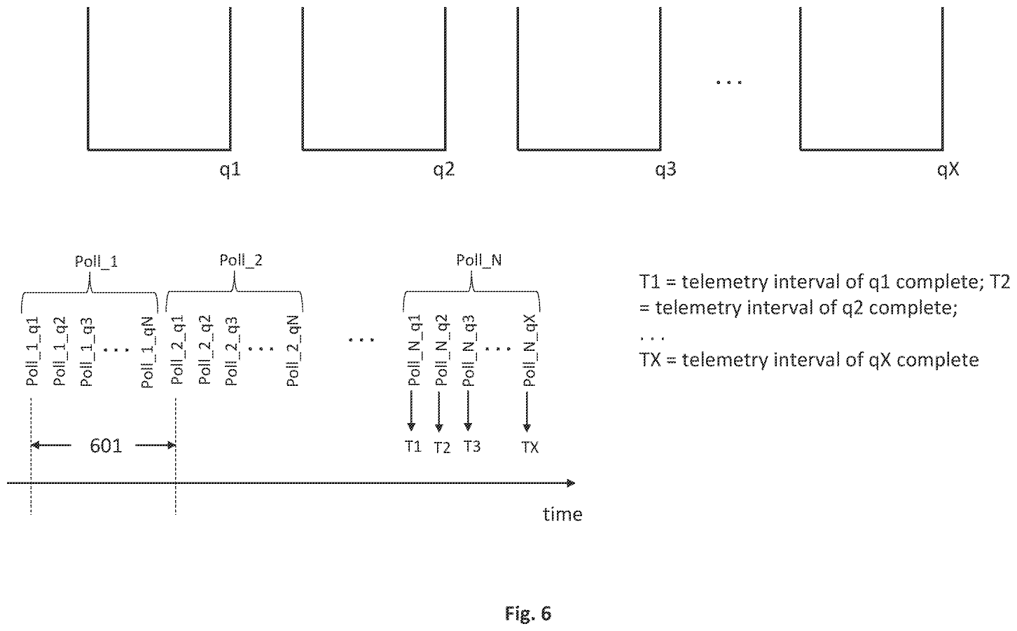

FIG. 6 shows an embodiment for polling telemetry intervals across multiple input queues. Here, the polling routine polls X input queues (q1 through qX) in round robin fashion (a first poll for each of the different queues is first performed (“Poll 1”), then a second poll for each of the different queues is next performed (“Poll 2”), etc.) until an Nth poll is performed for each of the different queues (“Poll N”). The telemetry interval for each queue is marked after each queue's Nth poll (T1 is Nth poll for q1, T2 is Nth poll for q2, etc.). The process then repeats for a next telemetry interval.

Accordingly, the time consumed to poll across all X queues affects the time 601 between consecutive polls within a same queue. Here, if Y seconds are consumed polling a same poll across all X queues, then, consecutive polls within a same queue are performed on the order of every Y seconds. Notably, the idle/busy poll determinations for the different queues can vary widely (the processor may be keeping up with some queues but not with others).

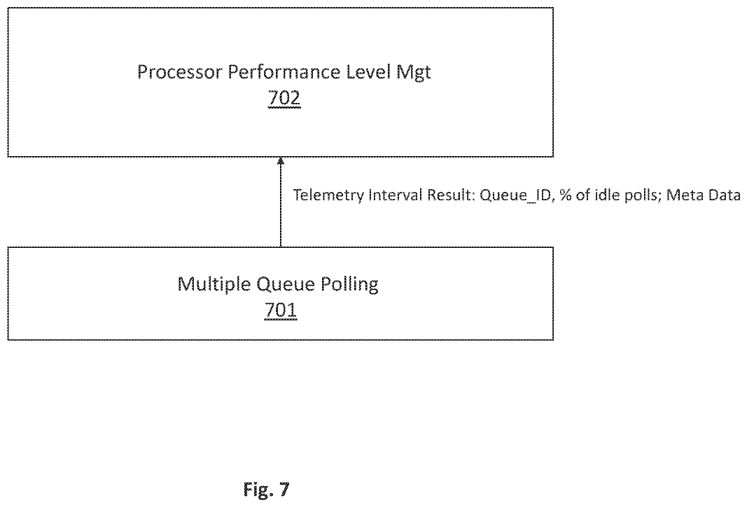

FIG. 7 shows an architecture that includes a polling function 701 that determines the different telemetry results (work item input flow metrics) from the different queues (e.g., as described above with respect to FIG. 6) and reporting them to a processor performance level function 702 that determines the appropriate processor performance level based on the reported telemetry results. Here, as observed in FIG. 7, when a telemetry interval has been completed for a particular queue, the polling function 701 identifies the queue (and/or meta data associated with the particular queue) and the telemetry interval result for the queue. The processor performance level function 702 accumulates the different telemetry interval results for the different queues and determines an appropriate processor performance level setting based on the telemetry data.

Here, a particular telemetry interval result for a particular queue can include meta data that is associated with the queue and that is used (or can be used) by the processor performance level function 702 to determine the appropriate processor performance level. Examples of such meta data include any/all of: 1) the identity of a virtual machine that the process or application that is consuming the queue's work items is running on; 2) the identity of a container that the process or application that is consuming the queue's work items is running within (the version and/or type of the container can also be included); 3) the identity of a process or thread that is consuming the queue's work items; 4) the identity of the processing core and/or multicore processor that is consuming the queue's work item's (the version and/or type of the core/processor can also be included).

With such meta data the processor performance level function 701 can implement various policies. Such policies may be focused only on the processor that is consuming the work items or may be global policies that determine performance levels for multiple processors including the processor that is consuming the work items. In the case of the later, function 701 may determine the performance and power consumption of a cluster of computing power such as a data center.

Regardless, the meta data helps the processor performance level function 701 implement any of a wide number of policies such as prioritizing the performance of certain VMs, threads, processes applications, etc., and/or, setting minimum performance levels for one or more VMs, threads, processes applications, etc., and/or, setting maximum power consumption levels for one or more VMs, threads, processes applications, etc.

As just one example, if a first queue feeds a high priority application whereas a second queue feeds a low priority application, the processor performance level function 701 may choose to increase the performance level of the processor because the telemetry results indicate the processor is not keeping up with work items being entered in the first queue even though the telemetry results also indicate the processor is over-servicing the second queue (threshold 501 in FIG. 5 is greatly exceeded).

According to another possible policy, the performance level is set to ensure that the processor is at least keeping up with all queues. In this case, the processor's performance level will be driven by the input queue that is receiving the highest rate of input work items. With the bursty nature of input work item flows, which particular input queue is busiest can vary over time. Thus, processor performance level is adjusted over time based on the input flow rate of whichever input queue is currently busiest.

With respect to the actual polling action, whether for a single queue or multiple queues, in various embodiments, a queue state counter is assigned to a queue and the counter is incremented each time a work item is entered in the queue and is decremented each time a work item is serviced from the queue. Here, whatever logic is controlling the entrance of work items to the queue is provided access to the memory or register location where the queue's counter is maintained so that the logic can increment the counter when entering a work item in the queue. Likewise, the processor is provided access to the memory or register location so that the counter can be decremented when servicing a work item from the queue. In various embodiments if the counter is maintained in memory it is the same memory where the queue resides. If the counter is maintained in a register, the register is located on the processor.

A second count value can be implemented in second memory or register space that is associated with the above described queue state register. The second count value records, e.g., how many polls within a current telemetry interval have occurred in which the queue was empty (idle). The polling hardware and/or software accesses the queue state counter each time a poll of the queue is to occur. In various embodiments, if the count value in the queue state counter is a null value (zero) there are no work items in the queue. The polling hardware and/or software increments the second count value as appropriate, e.g., according to the state diagram of FIG. 4a.

Although embodiments above have stressed actual measurement of the queue state, in various embodiments another parameter that is directly correlated to queue state is measured instead. For example, if received packet headers are to be entered into the input queue, the rate at which packets are being received at a network interface that feeds the input queue is measured instead.

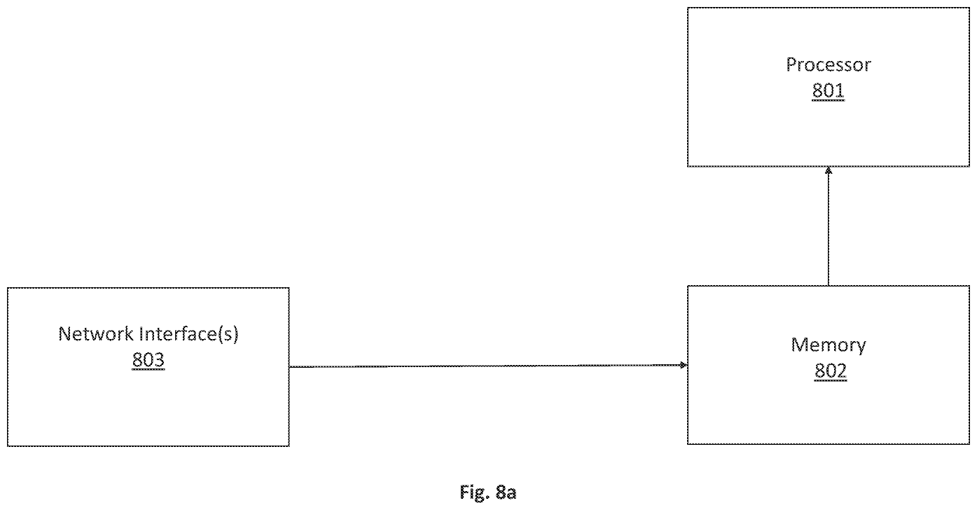

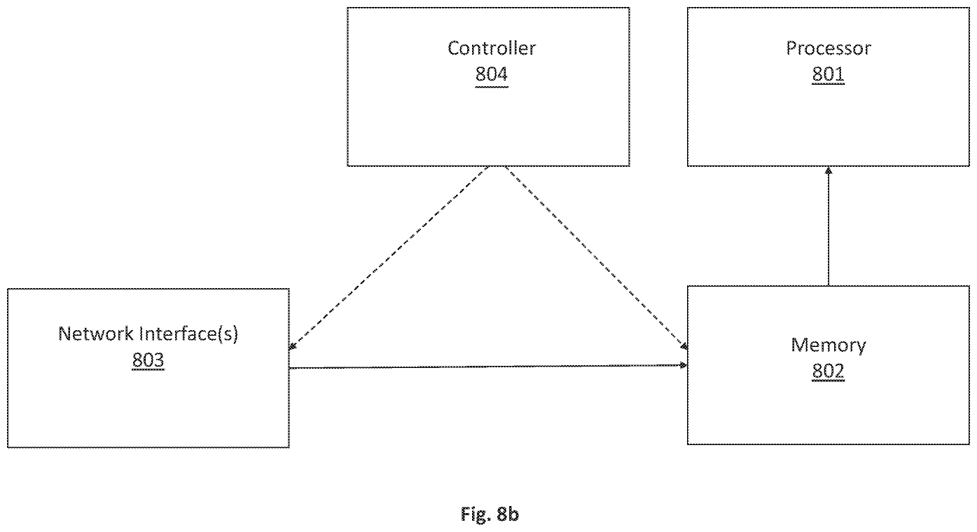

FIGS. 8a and 8b pertain to different possible hardware architectures for implementing the above described polling and corresponding processor management. Both of FIGS. 8a and 8b assume that the work items are packets and the source of the work items (packets) is one or more network interface(s) 803 that receive the packets from one or more networks. In other implementations, the source of the work items could be something else (e.g., one or more mass storage devices, digitized external analog/physical stimuli, etc.).

The received packets are directed from the network interface(s) 803 to a memory 802 that a processor 801 that processes the work items is coupled to. As described above, one or more queues could be realized in the memory 802 by directing packets to be processed by a particular process to that process's dedicated queue (in the case of multiple processes, the processor 801 is assumed to be capable of concurrently executing multiple processes which correspond to different applications, different threads, different execution units within the processor 801, etc.).

According to the implementation of FIG. 8a, the processor 801 pulls the packets from the network interface(s) 803 and places them into the queue(s) in memory 802 and/or the network interface(s) 803 push the packets into the queue(s) in memory 802. In the former, the processor 802 is controlling the flow of packets into memory 802 whereas, in the later, the network interface(s) 803 are controlling the flow of packets into memory 802. In the case of the later, the interface(s) 803 can make use of a direct memory access (DMA) or remote direct memory access (RDMA) transfer process to push the packets into memory 802.

Here, the processor 801 executes the polling algorithms of the queue(s) in memory 802 and either controls its own performance level in view of the respective state(s) of the queue(s) and/or reports the queue telemetry results to some other function in the system that controls system performance vs. power tradeoffs.

In the case of FIG. 8b, a controller 804 that is external from the processor 801 and the interface(s) 803 controls the flow of packets from the network interface(s) 803 into the queue(s) in memory 802. Here, for example, the processor 801 is some kind of off-load processor (e.g., graphics processor, accelerator, image processor, artificial intelligence inference engine, artificial intelligence learning engine, infrastructure processing unit (IPU), Neural Network Processor (NNP), “X” processing unit (XPU), etc.) and the controller 804 is one or more general purpose CPU cores of a multicore general purpose processor. The processor 801 can also be a general purpose processor including a multicore general purpose processor.

According to one approach, the controller 804 performs the polling of the queue(s) in memory 802. The controller 804 can further perform performance level control of the processor 801 in response to the telemetry results from the queue(s) and/or report the queue telemetry results to some other function in the system that controls system performance vs. power tradeoffs.

According to another approach, the processor 801 performs the polling of the queue(s) in memory 802 and further perform performance level control of the processor 801 in response to the telemetry results from the queue(s). Alternatively or in combination, the processor 801 performs the polling of the queue(s) in memory and reports the queue telemetry results to some other function in the system, such as controller 804 that also controls system performance vs. power tradeoffs.

In various embodiments, the queue polling is managed and/or the telemetry results are reported through an application programming interface (API) such as the Open Data Plane (ODP) API, a Data Plane Development Kit (DPDK) API, etc. Additionally, because the aforementioned polling and telemetry processes described above can be applied to packets that are flowing through a network, the teachings above can be applied to “in network telemetry” solutions/applications.

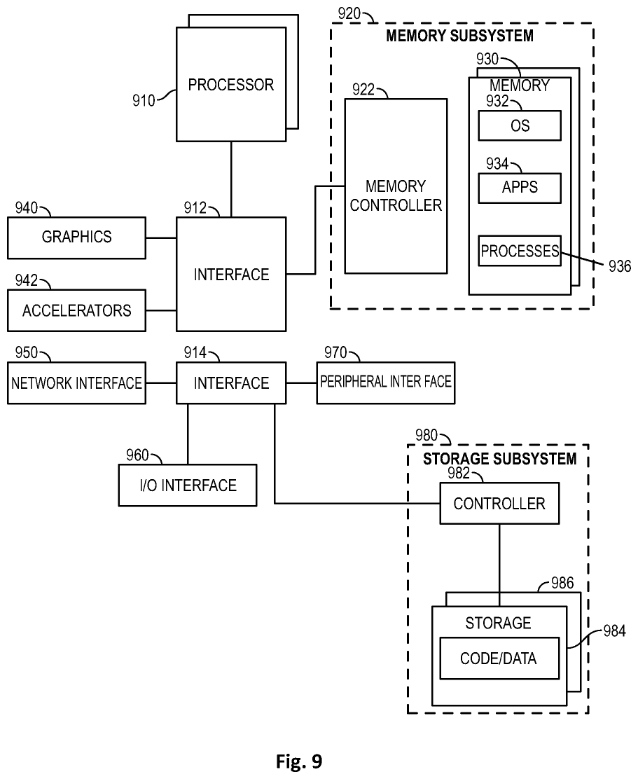

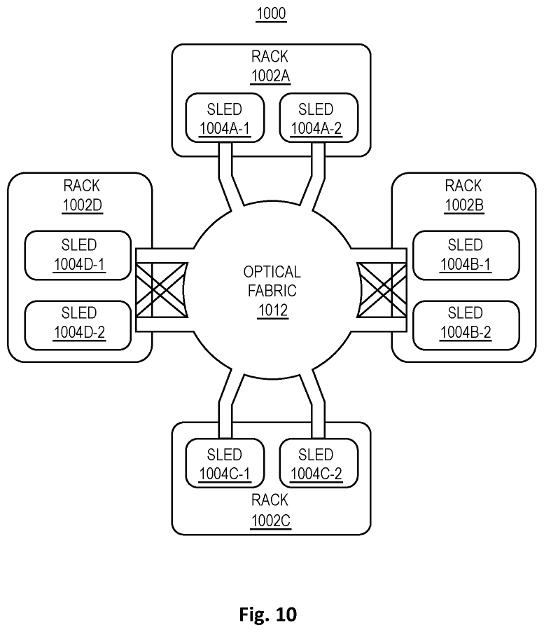

The following discussion concerning FIGS. 9, 10, and 11 are directed to systems, data centers and rack implementations, generally. FIG. 9 generally describes possible features of an electronic system that can include ingress queue and busyness metric calculation functionality as described above. FIG. 9 describes possible features of a data center that can include such electronic systems. FIG. 10 describes possible features of a rack having one or more such electronic systems.

FIG. 9 depicts an example system. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Certain systems also perform networking functions (e.g., packet header processing functions such as, to name a few, next nodal hop lookup, priority/flow lookup with corresponding queue entry, etc.), as a side function, or, as a point of emphasis (e.g., a networking switch or router). Such systems can include one or more network processors to perform such networking functions (e.g., in a pipelined fashion or otherwise).

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a fixed function offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), “X” processing units (XPUs), programmable control logic circuitry, and programmable processing elements such as field programmable gate arrays (FPGAs). Accelerators 942, processor cores, or graphics processing units can be made available for use by artificial intelligence (AI) or machine learning (ML) models. For example, the AI model can use or include any or a combination of a reinforcement learning scheme, Q-learning scheme, deep-Q learning, or Asynchronous Advantage Actor-Critic (A3C), convolutional neural network, recurrent convolutional neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, volatile memory, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software functionality to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910. In some examples, a system on chip (SOC or SoC) combines into one SoC package one or more of: processors, graphics, memory, memory controller, and Input/Output (I/O) control logic circuitry.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory), JESD235, originally published by JEDEC in October 2013, LPDDR5, HBM2 (HBM version 2), or others or combinations of memory technologies, and technologies based on derivatives or extensions of such specifications.

In various implementations, memory resources can be “pooled”. For example, the memory resources of memory modules installed on multiple cards, blades, systems, etc. (e.g., that are inserted into one or more racks) are made available as additional main memory capacity to CPUs and/or servers that need and/or request it. In such implementations, the primary purpose of the cards/blades/systems is to provide such additional main memory capacity. The cards/blades/systems are reachable to the CPUs/servers that use the memory resources through some kind of network infrastructure such as CXL, CAPI, etc.

The memory resources can also be tiered (different access times are attributed to different regions of memory), disaggregated (memory is a separate (e.g., rack pluggable) unit that is accessible to separate (e.g., rack pluggable) CPU units), and/or remote (e.g., memory is accessible over a network).

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a HyperTransport or industry standard architecture (ISA) bus, a small computer system interface (SCSI) bus, Remote Direct Memory Access (RDMA), Internet Small Computer Systems Interface (iSCSI), NVM express (NVMe), Coherent Accelerator Interface (CXL), Coherent Accelerator Processor Interface (CAPI), Cache Coherent Interconnect for Accelerators (CCIX), Open Coherent Accelerator Processor (Open CAPI) or other specification developed by the Gen-z consortium, a universal serial bus (USB), or an Institute of Electrical and Electronics Engineers (IEEE) standard 1394 bus.

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a remote device, which can include sending data stored in memory. Network interface 950 can receive data from a remote device, which can include storing received data into memory. Various embodiments can be used in connection with network interface 950, processor 910, and memory subsystem 920.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits in both processor 910 and interface 914.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base, and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented as a disaggregated computing system. For example, the system 900 can be implemented with interconnected compute sleds of processors, memories, storages, network interfaces, and other components. High speed interconnects can be used such as PCIe, Ethernet, or optical interconnects (or a combination thereof). For example, the sleds can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Although a computer is largely described by the above discussion of FIG. 9, other types of systems to which the above described invention can be applied and are also partially or wholly described by FIG. 9 are communication systems such as routers, switches, and base stations.

FIG. 10 depicts an example of a data center. Various embodiments can be used in or with the data center of FIG. 10. As shown in FIG. 10, data center 1000 may include an optical fabric 1012. Optical fabric 1012 may generally include a combination of optical signaling media (such as optical cabling) and optical switching infrastructure via which any particular sled in data center 1000 can send signals to (and receive signals from) the other sleds in data center 1000. However, optical, wireless, and/or electrical signals can be transmitted using fabric 1012. The signaling connectivity that optical fabric 1012 provides to any given sled may include connectivity both to other sleds in a same rack and sleds in other racks.

Data center 1000 includes four racks 1002A to 1002D and racks 1002A to 1002D house respective pairs of sleds 1004A-1 and 1004A-2, 1004B-1 and 1004B-2, 1004C-1 and 1004C-2, and 1004D-1 and 1004D-2. Thus, in this example, data center 900 includes a total of eight sleds. Optical fabric 1012 can provide sled signaling connectivity with one or more of the seven other sleds. For example, via optical fabric 1012, sled 1004A-1 in rack 1002A may possess signaling connectivity with sled 1004A-2 in rack 1002A, as well as the six other sleds 1004B-1, 1004B-2, 1004C-1, 1004C-2, 1004D-1, and 1004D-2 that are distributed among the other racks 1002B, 1002C, and 1002D of data center 1000. The embodiments are not limited to this example. For example, fabric 1012 can provide optical and/or electrical signaling.

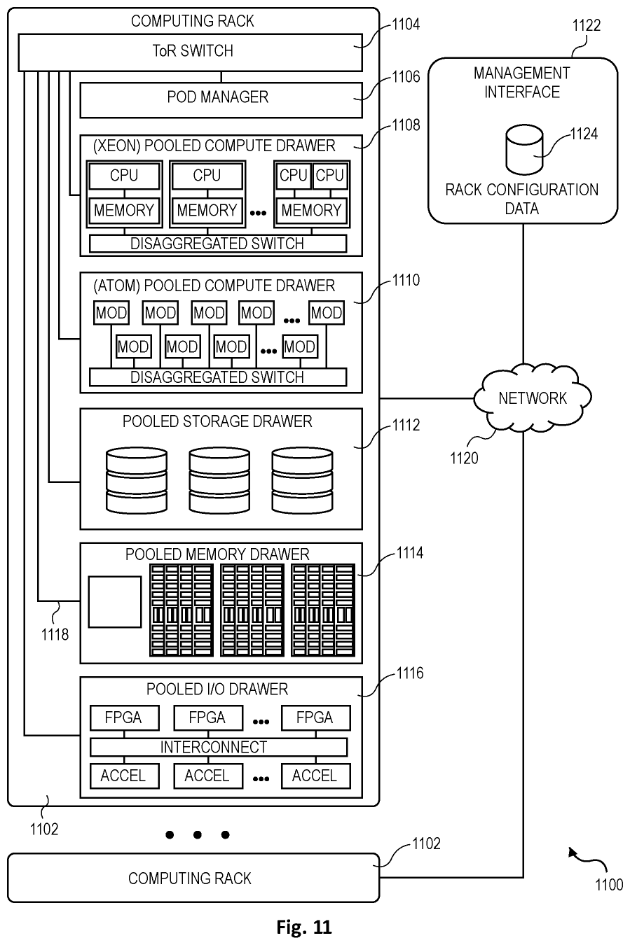

FIG. 11 depicts an environment 1100 that includes multiple computing racks 1102, each including a Top of Rack (ToR) switch 1104, a pod manager 1106, and a plurality of pooled system drawers. Generally, the pooled system drawers may include pooled compute drawers and pooled storage drawers to, e.g., effect a disaggregated computing system. Optionally, the pooled system drawers may also include pooled memory drawers and pooled Input/Output (I/O) drawers. In the illustrated embodiment the pooled system drawers include an INTEL® XEON® pooled computer drawer 1108, and INTEL® ATOM™ pooled compute drawer 1110, a pooled storage drawer 1112, a pooled memory drawer 1114, and a pooled I/O drawer 1116. Each of the pooled system drawers is connected to ToR switch 1104 via a high-speed link 1118, such as a 40 Gigabit/second (Gb/s) or 100 Gb/s Ethernet link or an 100+ Gb/s Silicon Photonics (SiPh) optical link. In one embodiment high-speed link 1118 comprises an 600 Gb/s SiPh optical link.

Again, the drawers can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Multiple of the computing racks 1100 may be interconnected via their ToR switches 1104 (e.g., to a pod-level switch or data center switch), as illustrated by connections to a network 1120. In some embodiments, groups of computing racks 1102 are managed as separate pods via pod manager(s) 1106. In one embodiment, a single pod manager is used to manage all of the racks in the pod. Alternatively, distributed pod managers may be used for pod management operations. RSD environment 1100 further includes a management interface 1122 that is used to manage various aspects of the RSD environment. This includes managing rack configuration, with corresponding parameters stored as rack configuration data 1124.

Any of the systems, data centers or racks discussed above, apart from being integrated in a typical data center, can also be implemented in other environments such as within a bay station, or other micro-data center, e.g., at the edge of a network.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds, and other design or performance constraints, as desired for a given implementation.

Some examples may be implemented using or as an article of manufacture or at least one computer-readable medium. A computer-readable medium may include a non-transitory storage medium to store program code. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the program code implements various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled, and/or interpreted programming language.

To the extent any of the teachings above can be embodied in a semiconductor chip, a description of a circuit design of the semiconductor chip for eventual targeting toward a semiconductor manufacturing process can take the form of various formats such as a (e.g., VHDL or Verilog) register transfer level (RTL) circuit description, a gate level circuit description, a transistor level circuit description or mask description or various combinations thereof. Such circuit descriptions, sometimes referred to as “IP Cores”, are commonly embodied on one or more computer readable storage media (such as one or more CD-ROMs or other type of storage technology) and provided to and/or otherwise processed by and/or for a circuit design synthesis tool and/or mask generation tool. Such circuit descriptions may also be embedded with program code to be processed by a computer that implements the circuit design synthesis tool and/or mask generation tool.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software, and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences may also be performed according to alternative embodiments. Furthermore, additional sequences may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

1. A method, comprising:
polling a queue a plurality of times over a plurality of intervals, where, the queue feeds work items to a processor;
determining, from the polling, respective work item flow metrics for the plurality of intervals; and,
determining a processor's performance setting based on the respective plurality of work item flow metrics.

2. The method of claim 1 wherein the work item flow metrics comprise meta data, the meta data comprising at least one of the following:
i) an identity of a virtual machine that the work items are processed on;
ii) a version of a virtual machine that the work items are processed on;
iii) an identity of a container that the work items are processed within;
iv) a type and/or version of a container that the work items are processed within;
v) an identity of a thread that processes the work items; or,
vi) an identity of the processor.

3. The method of claim 1 wherein the queue is implemented in memory that is accessible to the processor.

4. The method of claim 3 wherein the processor is any of:
a general purpose processor;
a graphics processor;
an accelerator;
a network processor; and,
an infrastructure processing unit.

5. The method of claim 1 wherein respective time spans of the intervals are based on a burst time of the work items.

6. The method of claim 1 wherein the polling comprises accessing a register or memory space where a counter for the queue is maintained, wherein the counter identifies how many work items are in the queue.

7. The method of claim 1 wherein the polling comprises determining if the queue is empty and the determining of the processor's performance level comprises determining, for each of the intervals, if a threshold of empty polls has been reached.

8. A computer readable storage medium containing program code that when processed by one or more processors causes a method to be performed, the method comprising:
polling a queue a plurality of times over a plurality of intervals, where, the queue feeds work items to a processor;
determining, from the polling, respective work item flow metrics for the plurality of intervals; and,
causing the respective work item flow metrics to be sent to a performance level determination function of the processor.

9. The computer readable storage medium of claim 8 wherein the work item flow metrics comprise meta data, the meta data comprising at least one of the following:
i) an identity of a virtual machine that the work items are processed on;
ii) a version of a virtual machine that the work items are processed on;
iii) an identity of a container that the work items are processed within;
iv) a type and/or version of a container that the work items are processed within;
v) an identity of a thread that processes the work items; or,
vi) an identity of the processor.

10. The computer readable storage medium of claim 8 wherein the queue is implemented in memory that is accessible to the processor.

11. The computer readable storage medium of claim 10 wherein the processor is any of:
a general purpose processor;
a graphics processor;
an accelerator;
a network processor; and,
an infrastructure processing unit.

12. The computer readable storage medium of claim 8 wherein respective time spans of the intervals are based on a burst time of the work items.

13. The computer readable storage medium of claim 8 wherein the polling comprises accessing a register or memory space where a counter for the queue is maintained, wherein the counter identifies how many work items are in the queue.

14. The computer readable storage medium of claim 8 wherein the polling comprises determining if the queue is empty.

15. A data center, comprising:
a) a plurality of computers communicatively coupled by one or more networks;
b) a plurality of racks, the plurality of computers respectively mounted to the plurality of racks;
c) a first computer readable storage medium containing first program code that when processed by at least one of the computers causes a first method to be performed, the method comprising:
polling a plurality of queues a plurality of times over a plurality of intervals, where, the plurality of queues respectively feed work items to a plurality of application software programs that execute on a computer of the plurality of computers;
determining, from the polling, respective work item flow metrics for the plurality of queues for the plurality of intervals; and,
d) a second computer readable storage medium containing second program code that when processed by the computer causes a performance level of a processor of the computer to be determined from the respective work item flow metrics.

16. The data center of claim 15 wherein the respective work item flow metrics comprise meta data, the meta data comprising at least one of the following:
i) an identity of a virtual machine of the computer that the work items are processed on;
ii) a version of a virtual machine of the computer that the work items are processed on;
iii) an identity of a container of the computer that the work items are processed within;
iv) a type and/or version of a container of the computer that the work items are processed within;
v) an identity of a thread of the computer that processes the work items; or,
vi) an identity of the processor.

17. The data center of claim 15 wherein the plurality of queues are implemented in memory of the computer.

18. The data center of claim 15 wherein respective time spans of the intervals are based on a burst time of the work items.

19. The data center of claim 15 wherein the polling comprises accessing register or memory space where counters for the queues are maintained, wherein the counters respectively identify how many work items are in the queues.

20. The data center of claim 15 wherein the polling comprises respectively determining if the queues are empty.
